(19) United States
(12) Patent Application Publication
(10) Pub. No.: US 2007/0150332 A1
(43) Pub. Date: Jun. 28, 2007

(54) Heuristic supply chain modeling method and system

(75) Inventors: Anthony J. Grichnik, Peoria, IL (US); Brian E. Beer, Yorkville, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/314,247

(22) Filed: Dec. 22, 2005

(51) Int. Cl. G07G 1/00; G06F 17/30

(52) U.S. Cl. 705/10

(57) ABSTRACT

A method is provided for supply chain modeling by a supply chain entity within a supply chain including a plurality of supply chain entities. The method may include obtaining an order fulfillment requirement for a product from a downstream supply chain entity and identifying one or more representative subsystems of the product. The method may also include determining a supply capacity and an inventory requirement for the supply chain entity with respect to the one or more representative subsystems and calculating an inventory cost for the supply chain entity based on the inventory requirement with respect to the one or more representative subsystems.

### TECHNICAL FIELD

This disclosure relates generally to supply chain modeling techniques and, more particularly, to methods and computer systems for modeling supply chain requirements using heuristic approaches.

### BACKGROUND

Supply chain planning, often being the logistical plan of an in-house supply chain, may be essential to the success of many of today's manufacturing firms. Most manufacturing firms may rely on supply chain planning to ensure the timely delivery of products in response to customer demands, such as to ensure the smooth functioning of different aspects of production, from the ready supply of components to meet production demands to the timely transportation of finished goods from the factory to the customer.

Modern supply chain planning may often include a wide range of variables, extending from distribution and production planning driven by customer orders, to materials and capacity requirements planning, to shop floor scheduling, manufacturing execution, and deployment of products. A vast array of data may be involved. To achieve successful supply chain planning, supply chain modeling may be used as a mathematical process tool to process and analyze the vast array of data and to determine various requirements of supply chain planning.

Certain techniques have been used to address supply chain modeling issues, such as large data amount, changing demand and capacity, dynamic supply chain flows, etc. For example, U.S. Pat. No. 6,477,660 to Sohner on Nov. 5, 2002, discloses a data model for a supply chain based on complex data base design and data processing techniques. These conventional techniques, however, often require significantly large scale computational methods and complex data gathering schemes to produce accurate supply chain models. The resultant heavy computational load and data gathering complexities may make it impractical for the supply chain models to respond to real-time changes in supply chain and may also make it difficult for users to understand results generated from those supply chain models.

Methods and systems consistent with certain features of the disclosed systems are directed to solving one or more of the problems set forth above.

### SUMMARY OF THE INVENTION

One aspect of the present disclosure includes a method for supply chain modeling by a supply chain entity within a supply chain including a plurality of supply chain entities. The method may include obtaining an order fulfillment requirement for a product from a downstream supply chain entity and identifying one or more representative subsystems of the product. The method may also include determining a supply capacity and an inventory requirement for the supply chain entity with respect to the one or more representative subsystems and calculating an inventory cost for the supply chain entity based on the inventory requirement with respect to the one or more representative subsystems.

Another aspect of the present disclosure includes a computer system provided for supply chain modeling by a supply chain entity within a supply chain. The computer may include a database containing information associated with a plurality of supply chain entities included in the supply chain and a processor. The processor may be configured to obtain an order fulfillment requirement for a product from a downstream supply chain entity and to identify one or more representative subsystems of the product. The processor may also be configured to determine a supply capacity and an inventory requirement for the supply chain entity with respect to the one or more representative subsystems and to calculate an inventory cost for the supply chain entity based on the inventory requirement with respect to the one or more representative subsystems.

Another aspect of the present disclosure includes a computer-readable medium for use on a computer system configured to perform a supply chain modeling procedure for a supply chain entity within a supply chain including a plurality of supply chain entities. The computer-readable medium includes computer-executable instructions for performing a method. The method may include obtaining an order fulfillment requirement for a product from a downstream supply chain entity and identifying one or more representative subsystems of the product. The method may also include determining a supply capacity and an inventory requirement for the supply chain entity with respect to the one or more representative subsystems and calculating an inventory cost for the supply chain entity based on the inventory requirement with respect to the one or more representative subsystems.

### BRIEF DESCRIPTION OF THE DRAWINGS

FIG. 1 illustrates an exemplary supply chain modeling environment consistent with certain disclosed embodiments;

FIG. 2 illustrates a block diagram of a computer system consistent with certain disclosed embodiments;

FIG. 3 shows a flowchart of an exemplary supply chain modeling process consistent with certain disclosed embodiments; and

FIG. 4 shows a flowchart of an exemplary capacity calculation and determination process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

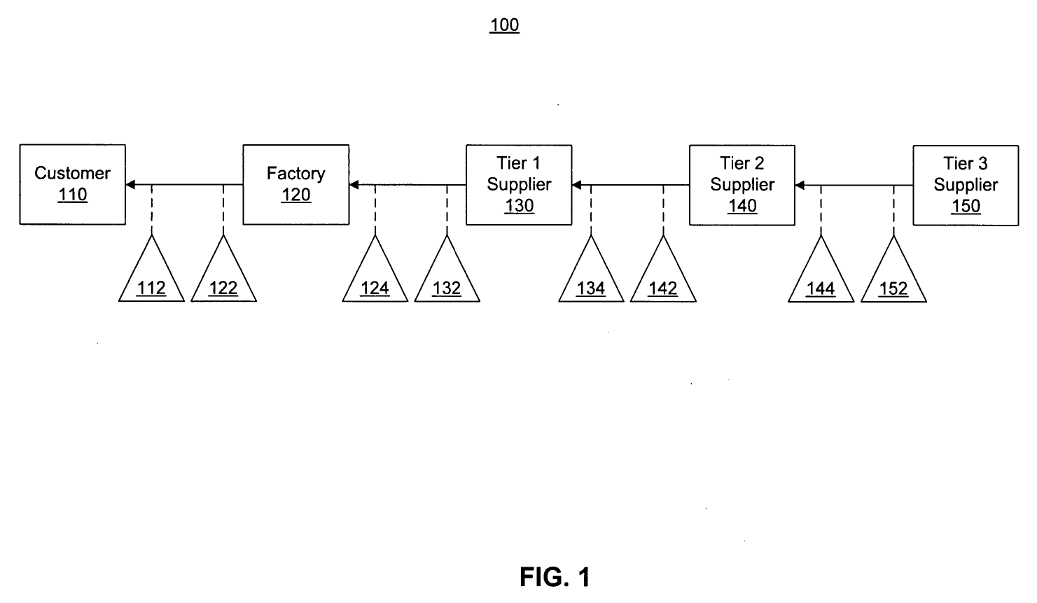

FIG. 1 illustrates a flowchart diagram of an exemplary supply chain modeling (SCM) environment 100. As shown in FIG. 1, SCM environment 100 may include a supply chain for a business organization, such as a factory. The supply chain may include supply chain entities, such as a customer 110, a factory 120, a tier 1 supplier 130, a tier 2 supplier 140, and a tier 3 supplier 150, etc. The number of the supply chain entities is exemplary only, any number of supply chain entities including any number of tiers of suppliers may be involved.

Factory 120 may include any business organization making or manufacturing products to be provided to customer 110. For example, factory 120 may be a work machine manufacturer to provide work machines ordered by customer 110. Work machine may refer to any type of fixed or mobile machine that performs some type of operation associated with a particular industry, such as mining, construction, farming, transportation, etc. and operates between or within work environments (e.g., construction site, mine site, power plants and generators, on-highway applications, etc.). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. Work machine may also refer to any type of commercial vehicles, such as cars, vans, pickup trucks, etc.

Customer 110 may include any customers of factory 120 who may demand that a particular manufacturing item be delivered by factory 120 before a certain date or time. A manufacturing item may include any product provided by factory 120, either tangible or intangible. For example, customer 110 may be a work machine dealer and may demand a delivery of certain number of work machines from factory 120.

Tier 1 supplier 130 may supply certain parts to factory 120. For example, tier 1 supplier 130 may supply engine systems, transmission systems, electronic systems, etc., to factory 120 to make work machines ordered by customer 110. Tier 2 supplier 140 may supply certain parts to tier 1 supplier 130. For example, tier 2 supplier 140 may supply fuel injectors, gear systems, controls system, etc., to tier 1 supplier 130 to make items that tier 1 supplier 130 may supply to factory 120 (e.g., engine systems, transmission systems, electronic systems, etc.).

Further, tier 2 supplier 140 may also be supplied by tier 3 supplier 150 to make items that tier 2 supplier 140 supplies to tier 1 supplier 130. The level of tiers of suppliers may be extended to a degree such that all supply chain entities may be supplied with what is required to fulfill the original demand made by customer 110. A current supply chain entity, the supply chain entity under modeling, may have one or more downstream supply chain entities that make demands and one or more upstream supply chain entities that supply products, parts, or subsystems. For example, factory 120 may have a downstream supply chain entity such as customer 110, and a upstream supply chain entity such as tier 1 supplier 130.

In fulfilling the demand from customer 110, factory 120, tier 1 supplier 130, tier 2 supplier 140, and tier 3 supplier 150 may acquire and/or maintain certain inventories of corresponding parts or subsystems. It may be desired that the total amount of inventories may be minimized to reduce inventory costs. Heuristic modeling methods may be used to process and analyze the inventory requirements for the supply chain entities to minimize the inventory costs.

Heuristic modeling methods, as used in the field of artificial intelligence, may refer to a rule of thumb approach that may be based on expert experience rather than an underlying theory or mathematical model. Heuristic models, created using the heuristic modeling method, may also be incorporated in knowledge bases and used to guide problem-solving processes.

A supply chain entity may include two types of inventories, downstream inventory and upstream inventory. Downstream inventory may include inventories of products, parts, or subsystems that a supply chain entity may need to keep before the products, parts, or subsystems may be accepted by the supply chain entity's downstream supply chain entity. For example, factory 120 may include a downstream inventory 122 of work machines before the work machines can be accepted by customer 110.

On the other hand, upstream inventory may include inventories of products, parts, or subsystems that a supply chain entity may need to keep before the products, parts, or subsystems may be used in manufacturing or other transactional processes. In the same example above, factory 120 may also include a upstream inventory 124 of engines from tier 1 supplier 130 before the work machines may be manufactured using the engines and other parts or subsystems. Further, similar to factory 120, customer 110 may include a upstream inventory 112; tier 1 supplier 130 may include a downstream inventory 132 and a upstream inventory 134; tier 2 supplier 140 may include a downstream inventory 142 and a upstream inventory 144; and tier 3 supplier 150 may include a downstream inventory 152; etc.

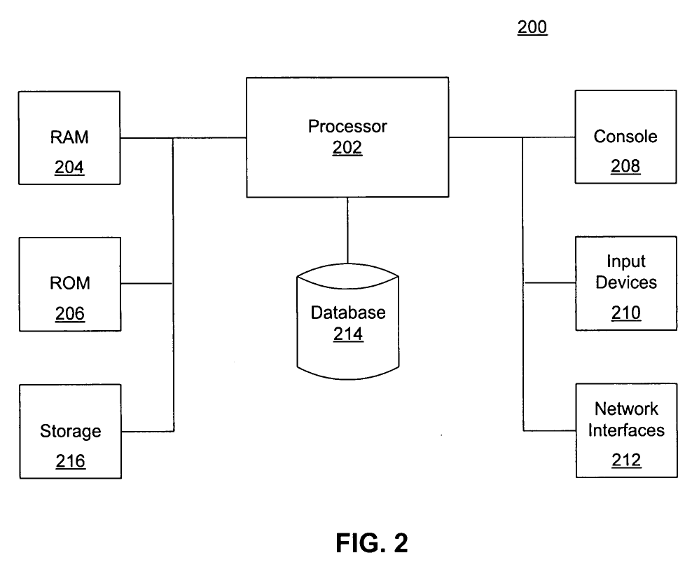

When customer 110 makes a demand to factory 120, these downstream inventories and upstream inventories listed above may be determined such that the demand can be fulfilled with minimum inventory cost based on heuristic supply chain models. The determination may be carried out according to disclosed embodiments by an exemplary computer system as shown in FIG. 2.

FIG. 2 shows an exemplary block diagram of computer system 200 to carry out heuristic supply chain modeling processes. Computer system 200 may include a processor 202, a random access memory (RAM) 204, a read-only memory (ROM) 206, a console 208, input devices 210, network interfaces 212, a database 214, and a storage 216. It is understood that the type and number of listed devices are exemplary only and not intended to be limiting. The number of listed devices may be changed and other devices may be added.

Processor 202 may include any appropriate type of general purpose microprocessor, digital signal processor, or microcontroller. Processor 202 may execute sequences of computer program instructions to perform various processes as explained above. The computer program instructions may be loaded into RAM 204 for execution by processor 202 from read-only memory (ROM) 206, or from storage 216. Storage 216 may include any appropriate type of mass storage provided to store any type of information that processor 202 may need to perform the processes. For example, storage 216 may include one or more hard disk devices, optical disk devices, or other storage devices to provide storage space.

Console 208 may provide a graphic user interface (GUI) to display information to users or administrators of computer system 200. Console 208 may include any appropriate type of computer display device or computer monitor. Input devices 210 may be provided for users to input information into computer system 200. Input devices 210 may include a keyboard, a mouse, or other optical or wireless computer input devices, etc. Further, network interfaces 212 may provide communication connections such that computer system 200 may be accessed remotely through computer networks via various communication protocols, such as transmission control protocol/internet protocol (TCP/IP), hyper text transfer protocol (HTTP), etc.

Database 214 may contain model data and/or any information related to data records under analysis, such as training and testing data. Database 214 may include any type of commercial or customized database. Database 214 may also include analysis tools for analyzing the information in the database. Processor 202 may also use database 214 to determine and store performance characteristics of supply chain modeling process.

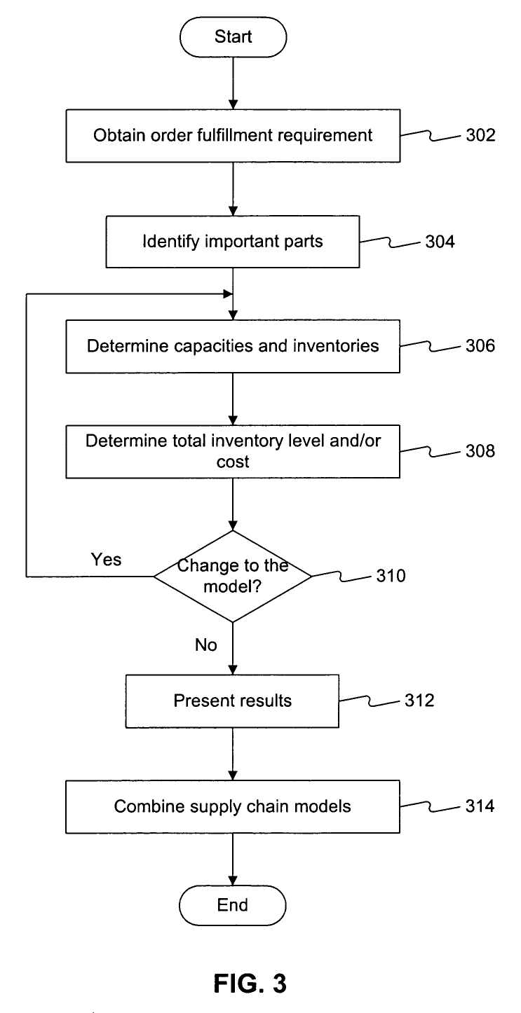

Processor 202 may execute computer programs to perform a heuristic supply chain modeling process for individual supply chain entities, such as factory 120. The computer programs may include any appropriate types of computer programs, such as application software programs, office software programs, etc. In one embodiment, the computer programs may include spread sheet software programs, such as Excel® software programs. FIG. 3 shows an exemplary modeling process that is implemented by the computer programs and performed by processor 202.

As show in FIG. 3, processor 202 may obtain an order fulfillment requirement or a demand from customer 110 (step 302). Customer 110 may order certain number of manufacturing items (e.g., work machines) from factory 120 and may set a guaranteed delivery date. Order fulfillment requirement may be represented by a total number of days between order placement and expected delivery of the certain number of items.

Processor 202 may identify important parts or subsystems of the ordered manufacturing items (step 304). Important parts may refer to parts or subsystems of a manufacturing item that are functionally and/or economically significant. For example, engine systems, transmission systems, electronic systems, etc., may be important parts of work machines ordered by customer 110.

Being functionally and/or economically significant, important parts or subsystems of a manufacturing item may often be deterministic on how and when the order fulfillment requirement may be fulfilled. Important parts or subsystems may also count for most of manufacturing costs and/or most of inventory costs. Important parts or subsystems may represent the manufacturing item, economically and/or functionally. On the other hand, supply chain entities may simply keep enough inventories on less important, thus less costly, parts without significant impact on the total inventory cost for the manufacturing item.

Inventory analysis and calculation may therefore be based on important parts and may omit or reduce the number of certain non-important parts or subsystems to reduce inventory variables and data complexity. For instance, in the work machine example above, inventory costs of work machines may be reflected by inventory costs of important parts such as engines, transmission systems, electronic systems, bodies of work machines, driving systems, etc. Less important parts, such as windshield wipers, light bulbs, internal decoration items, etc., may be kept in enough quantity to satisfy requirements from manufacturing processes. In one embodiment, an engine subsystem alone may be representative of the work machine.

Inventory may be represented in various terms, such as identification number, materials, total units, location, and/or unit cost, etc., with respect to individual parts or subsystems. In certain embodiments, inventory may also be represented by a period of time during which such parts or subsystems may be kept in inventory systems. For example, a five-day inventory of engines may represent a total of a five day supply of engines. The exact number of engines may be calculated based on the number of days (e.g., five) and the number of engines used each day during the manufacturing processes. Although individual parts or subsystems may be different physically and/or functionally, the different individual parts or subsystems may be represented in the same inventory term (i.e., the period of time) using the disclosed methods.

Further, inventory costs and/or requirements of important parts may be separately analyzed and processed to reduce complexity of supply chain modeling. Supply chain models for the important parts may be individually and/or separately created. The supply chain models may then be combined together to construct a supply chain model for the manufacturing items or for the whole supply chain entities. For the purpose of exemplary illustrations, inventory cost and requirement of the engine in the example above will be discussed in detail below. Other parts or subsystems, however, may also be modeled with the disclosed supply chain modeling methods.

After obtaining order fulfillment requirement (step 302) and identifying the important parts or subsystems (step 304), processor 202 may determine respective supply capacities and inventories of supply chain entities (step 306). For instance, in the work machine example above, customer 110 may set an overall order fulfillment requirement of 40 days for factory 120 to fulfill the order, processor 202 may determine supply capacities of supply chain entities such that the order may be fulfilled within 40 days. A supply capacity of a supply chain entity may include various processing and/or producing capabilities of the supply chain entity. For example, the supply capacity may include information processing capabilities, such as external order processing time, internal order processing time, inventory processing time, data processing time, and/or communication time, etc. The supply capacity may also include manufacturing capabilities, such as facility size, factory floor processing time, transition time, storage capacities, and/or delivery time of the parts or subsystems. Other capabilities, however, may also be included.

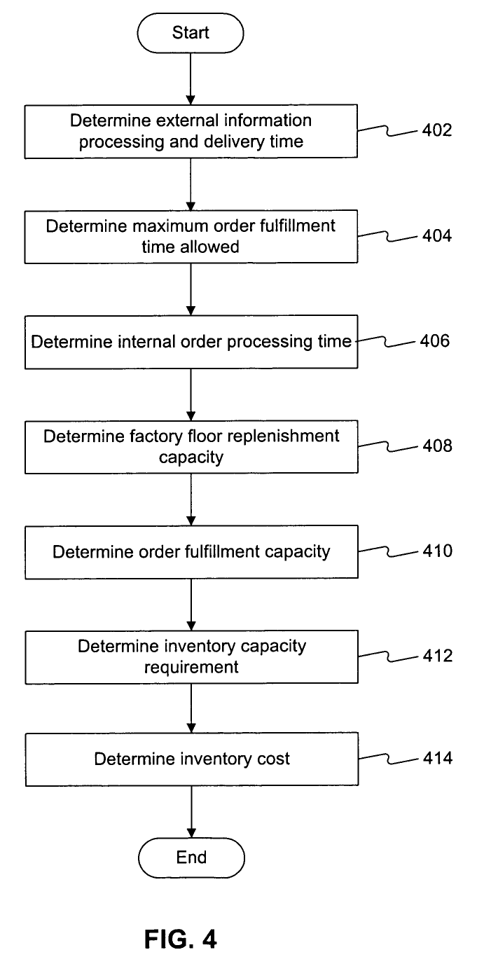

The supply capacity of the supply chain entity may be represented in any appropriate term, such as total number of items that can be processed or produced, total number of resources, such as number of staff and/or number of processing machines (e.g., computers, manufacturing machines, etc.). In certain embodiments, the supply capacity of the supply entity may also be represented by various periods of time as being consistent with the representation of inventories of the supply chain entity. That is, the supply capacity may be measured in term of time (e.g., days) and larger capacity may correspond to lesser time. The supply capacity may thus include various processing time parameters corresponding to physical and/or functional capacities of the supply chain entity. FIG. 4 shows an exemplary flowchart diagram of the capacity calculation and determination process.

As shown in FIG. 4, processor 202 may determine external information processing and delivery time of a current supply chain entity (step 402). External information processing and delivery time may include various capabilities of the supply chain entity to communicate with other supply chain entities and to transmit and/or receive products, parts, or subsystem to and/or from the other supply chain entities. As explained above, a current supply chain entity may refer to any supply chain entity that is under supply chain modeling. For instance, in the work machine example above, factory 120 may be the current supply chain entity. To determine the external information processing and delivery time, processor 202 may determine various parameters, such as communication time for factory 120 to receive an order from customer 110, the number of days during which work machine may be available to customer 110 before delivery (e.g., point of use), various shipment and transition times between factory 120 and customer 110, etc.

Processor 202 may determine the various parameters based on inputs from a user or users of computer system 200. For instance, the user may enter 1 day for communication time of the order from customer 110 to factory 120; 5 days for point of use before delivery; and 5 days of shipment and transition time between factory 120 and customer 110. Alternatively, processor 202 may determine the various time parameters automatically based on data from database 214 or based on data from other computer systems performing related tasks.

Processor 202 may calculate external information processing and delivery time in the supply chain model based on the various parameters. For example, processor 202 may determine the external information processing and delivery time as a sum of all the various parameters determined. That is, processor 202 may add together the 1 day for communication time, the 5 days for point of use, and the 5 days for shipment and transition time and may determine that the external information processing and delivery time is 11 days. Other calculation methods, however, may also be used.

Processor 202 may also determine supply chain entity maximum order fulfillment time allowed (step 404). Processor 202 may calculate the supply chain entity maximum order fulfillment time allowed based on an order fulfillment time requirement from a downstream supply chain entity and the external information processing and delivery time of the current supply chain entity. For example, for factory 120, maximum factory order fulfillment time allowed may be calculated by subtracting overall order fulfillment time from customer 110 (e.g., 40 days) by the external information processing and delivery time of factory 120 (e.g., 11 days). A total 29 days may be allowed for factory 120 to fulfill the order. Other calculation methods, however, may also be used.

Processor 202 may further determine internal order processing time (step 406). Internal order processing time may refer to the time spent by the current supply chain entity on processing any information related to order received from an upper stream supply chain entity during manufacturing processes. For example, internal order processing time may include time required for demand leveling, time required to receive order and process machine shipping order (MSO), time required to enter information into supply chain management systems, such as material resource planning (MRP), etc., and/or time required to release work instructions, etc. Internal order processing time may also include shipment time and transition time from other upstream supply chain entities.

In the example above, processor 202 may determine, based on user inputs, that the time required for demand leveling may be 0 day, the time required to receive order and process MSO may be 1 day, that the time required to enter information into supply chain management systems may be 5 days, and that the time required to release work instructions may be 1 day. Processor 202 may further determine the internal order processing time by adding up all the time listed. That is, processor 202 may determine a total of 7 days as the internal order processing time. Other calculation methods, however, may also be used.

Processor 202 may also determine factory floor replenishment capacity of the current supply chain entity (step 408). The factory floor replenishment capacity may refer to the capacity of the supply chain entity to re-supply parts or subsystems (e.g., engines) during the manufacturing processes. For example, processor 202 may determine that factory 120 may have a factory floor replenishment capacity of 10 days based on inputs from the user and/or from other computer systems.

After determining the above parameters, processor 202 may determine an order fulfillment capacity of the current supply chain entity (step 410). The order fulfillment capacity may include capabilities of the supply chain entity to complete the order in certain number of days. Processor 202 may determine order fulfillment capacity based on the internal order processing time and the factory floor replenishment capacity. In the example above, processor 202 may determine that the order fulfillment capacity of factory 120 may be a sum of the internal order processing time (e.g., 7 days) and the factory floor replenishment capacity (e.g., 10 days). A total of 17 days may be determined by processor 202 as the order fulfillment capacity. Other calculation methods, however, may also be used.

Processor 202 may also determine an inventory capacity requirement of the current supply chain entity (step 412). Inventory capacity requirement may refer to capabilities of the supply chain entities required to keep certain level of inventories. Processor 202 may determine the inventory capacity requirement based on the order fulfillment capacity and the maximum order fulfillment time allowed. If the order fulfillment capacity, in terms of time, is more than the maximum order fulfillment time allowed (i.e., the supply chain entity has less capacity to fulfill the order), a non-zero inventory capacity may be required.

For a particular product or subsystem and corresponding capabilities in terms of time, there may be one and only on non-zero minimum inventory level that satisfies the order fulfillment requirement. An inventory level may refer to a quantity of the inventory. The quantity of the inventory may be used to determine inventory requirements related to capacity for handling inventories, such as storage capacity, etc. The quantity of the inventory may also be used to determine inventory cost, which may include to any cost (e.g., time, resource, money, etc.) associated with the inventory. For example, the inventory cost may be related to factors such as costs associated with the handling of the inventory, costs associated with transferring the inventory, or locations to hold inventory, etc.

The non-zero inventory capacity requirement may be calculated as the difference between the order fulfillment capacity and the maximum order fulfillment time allowed. In the above example, factory 120 may have an inventory capacity requirement of 0 day in that the maximum order fulfillment time allowed (e.g., 29 days) is more than the order fulfillment capacity (e.g., 17 days). On the other hand, assuming that the maximum order fulfillment time is 10 days and the order fulfillment capacity is 20 days, 10 days of total inventory capacity may be required. Other calculation methods, however, may also be used.

The inventory capacity requirement of the current supply chain entity may include inventory requirements of a downstream supply chain entity and the current supply chain entity (i.e., a downstream inventory of the current supply chain entity and an upstream inventory of the upper stream supply chain entity). In the example above, because the inventory capacity requirement is zero, upstream inventory 112 and downstream inventory 122 may both be zero. However, on the other hand, assuming a 10 days of total inventory capacity is required, factory 120 may be allocated to have a 10-day downstream inventory 122 and customer 110 may be allocated to have a 0-day upstream inventory 112. In certain embodiments, inventory capacity may be allocated to a supply chain entity farther away from customer 110 such that inventory cost may be further reduced. Other allocation methods, however, may also be used.

Processor 202 may also determine inventory cost of the supply chain entities based on the inventory capacity required (step 414). Certain related variables about inventories of a particular supply chain entity, such as unit per day, cost per unit, etc., may be predetermined or provided by the user or other systems. For example, if a three-day inventory capacity is required; the related variables include unit per day and cost per unit; and unit per day is 10 and cost per day is $10,000, the cost of the inventory capacity may be calculated as: 3×10×$10,000=$300,000. Other calculation methods (e.g., carry cost method), however, may also be used.

Although calculations and determinations corresponding to factory 120 are illustrated above in detail, similar calculations and determinations may also be performed for any supply chain entity in the supply chain. Further, capacities including inventory capacities may be calculated along the supply chain by repeating the steps above because the calculations may be similar for individual supply chain entities. The calculations may be selected such that total number of calculations may be minimized for the part or entire supply chain. The calculations may be performed in sequence starting at the beginning of the supply chain and may be continued at any level of supply chain suppliers as desired. However, the further down the supply chain of a supply chain entity, the less impact that supply chain entity may have on the supply chain entities substantially ahead.

Returning to FIG. 3, after determining respective capacities of individual supply chain entities (step 306), processor 202 may determine a total inventory level and/or cost based on all entities in the supply chain (step 308). For example, processor 202 may add together all inventory level and/or costs from individual supply chain entities to calculate the total inventory level and/or cost. Other methods, however, may also be used. The supply chain model for the current supply chain entity may be completed and may be further used.

After establishing a supply chain model for a particular supply chain entity (e.g., factory 120) based on various time parameters and their interrelationships, as explained above, processor 202 may determine whether the user has changed the values of any of the parameters (step 310). The user may change the values of the various time parameters to achieve a desired total inventory level and/or cost. For example, the user may select a set of values of the time parameters such that the inventory level and/or cost is minimized. The select set of values may represent certain adjustments that the supply chain entity may perform. For example, the supply chain entity may increase the number of manufacturing facilities to increase factory order fulfillment capacity, improve information technology facilities to decrease information processing time, and/or increase shipping and handling facilities to reduce shipment and transition time, etc.

If the user changes the values of one or more time parameters (step 310; yes), processor 202 may re-calculate the inventory level and/or costs beginning at step 306. On the other hand, if the user does not change the values (step 310; no), processor 202 may proceed to present results of one or more above steps (step 312).

Processor 202 may present the results via any appropriate type of interface, including visual, audio, and/or textual interfaces, etc. Processor 202 may also display the results on console 208 with a graphical user interface (GUI).

Further, if there is more than one important part involved and supply chain models for each important part or subsystem have been established, processor 202 may also combine the supply chain models for individual parts or subsystems to establish a supply chain model for the manufacturing item comprising the important parts or subsystems (step 314). The combination of individual supply chain models may be statistical and/or functional. The combined supply chain model may be applied to an entire manufacturing item, such as a work machine.

Additionally, supply chain models of individual manufacturing items may be combined together to establish supply chain models for the entire enterprise. For example, a supply chain model for factory 120 may be established to cover all products made by factory 120, such as various types of work machines.

### INDUSTRIAL APPLICABILITY

The disclosed systems and methods may provide efficient and simple solutions for supply chain modeling. In particular, the disclosed systems and methods provide practical solutions to determine optimized and/or minimized inventory and capacity levels for a supply chain entity to fulfill a customer order by not taking into account all the factors of a large representation of an inventory problem, such as including a large number of parts or subsystems, and representing different parts or subsystems with different terms, etc., and by focusing on fewer or a single part. Further, the disclosed systems and methods may treat both inventory and capacity in terms of time rather than other terms particular to individual products, parts, or subsystems. By using supply chain model established in terms of time, complicating factors such as compatibility may be simplified because time may be universal to all parts or processes.

The disclosed systems and methods may be combined to establish a more comprehensive supply chain model for an entire enterprise, because each supply chain model for a single part or subsystem may be similar and combinable. Further, the disclosed systems and methods may be integrated into other modeling environments, such as other supply chain modeling environments so that users of the other design environments may use the disclosed systems and methods transparently (i.e., without knowing that the underlying supply chain model is established by the disclosed systems and methods).

Manufacturers or other similar business entities may use the disclosed systems and methods, or any part thereof, to internally assist manufacturing processes and/or to manage inventory. Parameters and methods other than explained in this disclosure (e.g., external information processing and delivery time, maximum order fulfillment time allowed, floor replenishment time, order fulfillment capacity, inventory capacity and cost, etc.) may also used with the disclosed systems and methods.

Further, computer software providers may also use the disclosed systems and methods to improve inventory management tools by incorporating the heuristic supply chain modeling method into the inventory management tools as add-ons or value enhancing services.

Other embodiments, features, aspects, and principles of the disclosed exemplary systems will be apparent to those skilled in the art and may be implemented in various environments and systems.

What is claimed is:

1. A method for supply chain modeling by a supply chain entity within a supply chain including a plurality of supply chain entities, comprising:
obtaining an order fulfillment requirement for a product from a downstream supply chain entity;
identifying one or more representative subsystems of the product;
determining a supply capacity and an inventory requirement for the supply chain entity with respect to the one or more representative subsystems; and
calculating an inventory cost for the supply chain entity based on the inventory requirement with respect to the one or more representative subsystems.

2. The method according to claim 1, further including:
determining a supply capacity and an inventory requirement for each of the plurality of supply chain entities corresponding to the one or more representative subsystems;
calculating an inventory cost for the each of the plurality of supply chain entities based on the respective inventory requirement for each of the plurality of supply chain entities corresponding to the one or more representative subsystems; and
deriving a total inventory level for the product by combining the respective inventory cost for the each of the plurality of supply chain entities.

3. The method according to claim 2, further including:
deriving a total inventory cost for the product based on the inventory level.

4. The method according to claim 1, wherein both the supply capacity and the inventory requirement are represented in terms of time.

5. The method according to claim 4, wherein the determining includes:
determining an external information processing and delivery time of the supply chain entity; and
determining a maximum order fulfillment time allowed for the supply chain entity based on the external information processing and delivery time and the order fulfillment requirement for the product.

6. The method according to claim 5, further including:
determining an internal order processing time of the supply chain entity;
determining a factory floor replenishment capacity of the supply chain entity; and
determining an order fulfillment capacity of the supply chain entity based on the internal order processing time and the factory floor replenishment capacity.

7. The method according to claim 6, further including:
determining an inventory capacity requirement of the supply chain entity based on the order fulfillment capacity and the maximum order fulfillment time allowed.

8. The method according to claim 1, wherein the calculating includes:
determining a daily unit cost corresponding to the inventory capacity requirement of the supply chain entity; and
determining an inventory cost based the inventory capacity requirement and the daily unit cost.

9. The method according to claim 1, wherein:
each successive upstream supply chain entity of the supply chain performs a substantially similar calculation on the inventory cost to that performed by a predecessor of the each successive upstream supply chain entity.

10. The method according to claim 9, wherein:
the calculation is selected to minimize a total number of calculations for the supply chain.

11. A computer system provided for supply chain modeling by a supply chain entity within a supply chain, the computer comprising:
a database containing information associated with a plurality of supply chain entities included in the supply chain; and
a processor configured to:
obtain an order fulfillment requirement for a product from a downstream supply chain entity;
identify one or more representative subsystems of the product;
determine a supply capacity and an inventory requirement for the supply chain entity with respect to the one or more representative subsystems; and
calculate an inventory cost for the supply chain entity based on the inventory requirement with respect to the one or more representative subsystems.

12. The computer system according to claim 11, the processor being further configured to:
determine a supply capacity and an inventory requirement for each of the plurality of supply chain entities corresponding to the one or more representative subsystems;
calculate an inventory cost for the each of the plurality of supply chain entities based on the respective inventory requirement for each of the plurality of supply chain entities corresponding to the one or more representative subsystems; and
derive a total inventory cost for the product by combining the respective inventory cost for the each of the plurality of supply chain entities.

13. The computer system according to claim 12, wherein both the supply capacity and the inventory requirement are represented in terms of time.

14. The computer system according to claim 12, wherein, to determine the supply capacity, the processor is further configured to:
determine an external information processing and delivery time of the supply chain entity; and
determine a maximum order fulfillment time allowed for the supply chain entity based on the external information processing and delivery time and the order fulfillment requirement for the product.

15. The computer system according to claim 14, wherein the processor is further configured to:
determine an internal order processing time of the supply chain entity;
determine a factory floor replenishment capacity of the supply chain entity; and
determine an order fulfillment capacity of the supply chain entity based on the internal order processing time and the factory floor replenishment capacity.

16. The computer system according to claim 15, wherein the processor is further configured to:
determine an inventory capacity requirement of the supply chain entity based on the order fulfillment capacity and the maximum order fulfillment time allowed.

17. The computer system according to claim 12, wherein, to calculate the inventory cost, the processor is further configured to:
determine a daily unit cost corresponding to the inventory capacity requirement of the supply chain entity; and
determine an inventory cost based the inventory capacity requirement and the daily unit cost.

18. The computer system according to claim 12, further including:
a display device configured to:
display one or more steps used by the processor to obtain the order fulfillment requirement; to identify the one or more representative subsystems; to determine the supply capacity and the inventory requirement; and to calculate the inventory cost.

19. A computer-readable medium for use on a computer system configured to perform a supply chain modeling procedure for a supply chain entity within a supply chain including a plurality of supply chain entities, the computer-readable medium having computer-executable instructions for performing a method comprising:
obtaining an order fulfillment requirement for a product from a downstream supply chain entity;
identifying one or more representative subsystems of the product;
determining a supply capacity and an inventory requirement for the supply chain entity with respect to the one or more representative subsystems; and
calculating an inventory cost for the supply chain entity based on the inventory requirement with respect to the one or more representative subsystems.

20. The computer-readable medium according to claim 19, wherein the method further includes:
determining a supply capacity and an inventory requirement for each of the plurality of supply chain entities with respect to the one or more representative subsystems;
calculating an inventory cost for the each of the plurality of supply chain entities based on the respective inventory requirement for each of the plurality of supply chain entities with respect to the one or more representative subsystems; and
deriving a total inventory cost for the product by combining the respective inventory cost for the each of the plurality of supply chain entities.

21. The computer-readable medium according to claim 19, wherein both the supply capacity and the inventory requirement are represented in terms of time, and the step of determining includes:
determining an external information processing and delivery time of the supply chain entity; and
determining a maximum order fulfillment time allowed for the supply chain entity based on the external information processing and delivery time and the order fulfillment requirement for the product.

22. The computer-readable medium according to claim 21, wherein the step of determining further includes:
determining an internal order processing time of the supply chain entity;
determining a factory floor replenishment capacity of the supply chain entity; and
determining an order fulfillment capacity of the supply chain entity based on the internal order processing time and the factory floor replenishment capacity.

23. The computer-readable medium according to claim 22, wherein the step of determining further includes:
determining an inventory capacity requirement of the supply chain entity based on the order fulfillment capacity and the maximum order fulfillment time allowed.
